(19) United States
(12) Patent Application Publication
(10) Pub. No.: US 2016/0309006 A1
(43) Pub. Date: Oct. 20, 2016

(54) NON-TRANSITORY COMPUTER-READABLE RECORDING MEDIUM AND DISTRIBUTED PROCESSING METHOD

(71) Applicant: FUJITSU LIMITED, Kawasaki-shi (JP)

(72) Inventors: Nobuyuki KUROMATSU, Kawasaki (JP); Haruyasu Ueda, Ichikawa (JP)

(73) Assignee: FUJITSU LIMITED, Kawasaki-shi (JP)

(21) Appl. No.: 15/072,490

(22) Filed: Mar. 17, 2016

(30) Foreign Application Priority Data
Apr. 16, 2015 (JP) 2015-084575

(51) Int. Cl. H04L 29/06; H04L 29/08

(52) U.S. Cl. CPC H04L 69/22; H04L 67/10

(57) ABSTRACT

A management server extracts header information from matrix data that includes the header information and data. The management server creates a plurality of pieces of divided matrix data that are obtained by dividing the matrix data in a row unit. The management server transmits header reference information relating to reference of the header information to each of a plurality of servers being a subject of instruction to which the divided matrix data are allocated.

### CROSS-REFERENCE TO RELATED APPLICATION

This application is based upon and claims the benefit of priority of the prior Japanese Patent Application No. 2015-084575, filed on Apr. 16, 2015, the entire contents of which are incorporated herein by reference.

### FIELD

The embodiments discussed herein are related to a computer-readable recording medium a distributed processing method, and an information processing apparatus.

### BACKGROUND

A general-purpose parallel processing framework for big data processing represented by Hadoop (registered trademark) has become widespread, and parallelization of data analysis is spreading as a scheme of analyzing large-scale data. There is a case in which data analysts that actually analyze data use a programming language suitable for data analysis such as an R language as a programming language for statistical analysis.

Generally, data used for analysis is prepared as a file in a CSV format and the like, and a header is set as data on a first row indicating the type of the data. Having determined by a developer of an R application in advance whether the R application that is developed in the R language handles the first row as an actual data or as a header, the R application in which a corresponding execution code is described is prepared.

When the R application is parallel executed on multiple servers using a parallel processing framework, parallel processing is executed by distributing large-scale data to the respective servers. Therefore, R applications that handles a header and that does not handle a header are appropriately provided in the respective servers of distribution destinations, to execute parallel processing of data analysis (Japanese Laid-open Patent Publication Nos. 2008-243193, 07-168890, and 09-16694).

However, in the above technique, because data obtained by automatically dividing large-scale data is input to the respective servers, data with a header and data without a header are given as an input in a mixed manner to the respective servers, and there is a case in which the R application is not executed properly. That is, by a constraint of the R language that an access method of data differs depending on a presence or absence of a header, the processing is not executed appropriately, to cause an error.

Even it is difficult for a developer that has knowledge of both parallelization and distribution processing to predict which server data with a heard is allocated to, and it is difficult to avoid an error in the R application. Moreover, a method in which a header is arranged at a different place, and a server of a distribution destination acquires the header therefrom can be considered. In this case, to search for a header corresponding to input data, metadata of the header is to be used. However, metadata of a header is stored only in a server that has actually stored the header, and therefore, a storage location is not identified by other servers and the header is not acquired by the other servers.

### SUMMARY

According to an aspect of the embodiment, a non-transitory computer-readable recording medium stores therein a program that causes a computer to execute a process. The process includes extracting header information from matrix data that includes the header information and data; creating a plurality of pieces of divided matrix data that are obtained by dividing the matrix data in a row unit; and transmitting header reference information relating to reference of the header information to each of a plurality of servers being a subject of instruction to which the divided matrix data are allocated.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 depicts an entire configuration example of a system according to a first embodiment;

FIG. 2 is a functional block diagram depicting a function configuration of respective devices according to the first embodiment;

FIG. 3 depicts a data example of input data;

FIG. 4 depicts an example of pass data;

FIG. 5 is an explanatory diagram of a method of determining that a header is present;

FIG. 6 is an explanatory diagram of a method of determining that a head is absent;

FIG. 7 is a flowchart indicating a flow of processing executed by a management server;

FIG. 8 is a flowchart indicating a flow of processing executed by a distributed processing server;

FIG. 9 is an explanatory diagram of an example of system stuck of the distributed processing server that executes MapReduce processing;

FIG. 10 is an explanatory diagram of an application example to MapReduce processing;

FIG. 11 is a flowchart indicating a flow of Map processing executed by a distributed processing server according to a second embodiment; and

FIG. 12 depicts a hardware configuration example of each server.

### DESCRIPTION OF EMBODIMENTS

Preferred embodiments will be explained with reference to accompanying drawings. The present invention is not limited to the embodiments.

### [a] First Embodiment

Entire Configuration

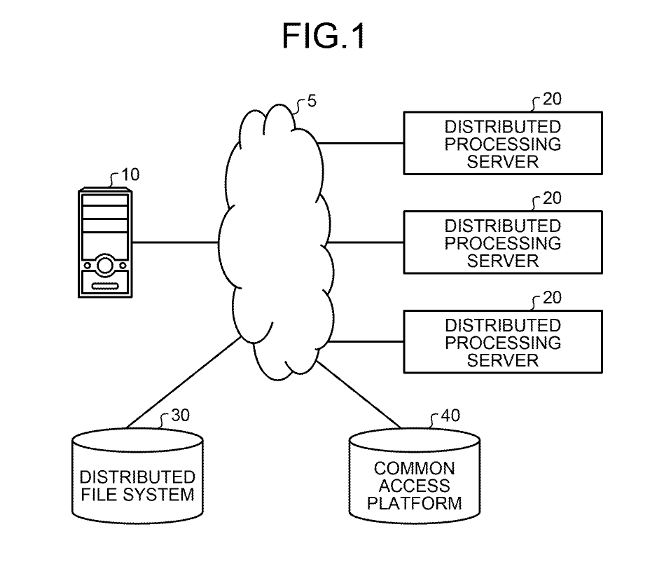

FIG. 1 depicts an entire configuration example of a system according to a first embodiment. As depicted in FIG. 1, this system is a distributed processing system in which a management server 10, multiple distributed processing servers 20, a distributed file system 30, and a common access platform 40 are connected through a network 5 so as to enable communication with each other. The system configuration indicated herein is one example, and the number of servers and configurations may be changed arbitrarily.

In this distributed processing system, a distributed processing application using a distributed processing framework such as Hadoop (registered trademark) is executed in each server, and a Hadoop distributed file system (HDFS) or the like is used as a data platform.

The management server 10 is one example of a server that manages distributed processing. This management server 10 stores data of a subject of distributed processing in the distributed file system 30 to perform management thereof, and distributes the data to the respective distributed processing servers 20 by dividing the data in a row unit.

Each of the distributed processing servers 20 is one example of a server of a subject of instruction that executes an R application developed in the R language, which is a programming language for statistical analysis. These distributed processing servers 20 executes various kinds of processing on data that is input from the management server 10. The R application that is executed by the distributed processing server 20 is developed so as to perform processing assuming that data includes a header.

The distributed file system 30 is one example of a database server that stores data of subject of distributed processing. Although explanation is given with an example in which the distributed file system 30 is connected to the network 5, it is not limited thereto, but it may be included in the management server 10 or each of the distributed processing servers 20. That is, data management using HDFS as a platform by each server is executed. Moreover, the common access platform 40 is one example of a server, database, and the like to which each server has an access.

In such a system configuration, the management server 10 extracts header information from matrix data that includes header information and data. The management server 10 then creates multiple pieces of divided matrix data that are obtained by dividing the matrix data in a row unit. The management server 10 transmits header reference information relating to reference of header information to each of the distributed processing servers 20 to which the divided matrix data are allocated.

Each of the distributed processing servers 20 receives the header reference information relating to reference of header information of the matrix data that includes the header information and data. Subsequently, each of the distributed processing servers 20 receives the divided matrix data that is obtained by dividing the matrix data in a row unit. Each of the distributed processing servers 20 executes predetermined processing on the divided matrix data when the header information is included in the divided matrix data. Furthermore, each of the distributed processing servers 20 acquires the header information using the header reference information to perform predetermined processing when the header information is not included in the divided matrix data.

That is, the management server 10 transmits pass information that indicates a storage location of a header of matrix data to each of the distributed processing servers 20 together with matrix data. As a result, even when the R application with the assumption of presence of a header is provided to each of the distributed processing servers 20, each of the distributed processing servers 20 can perform appropriate processing even on data without a header.

Functional Configuration

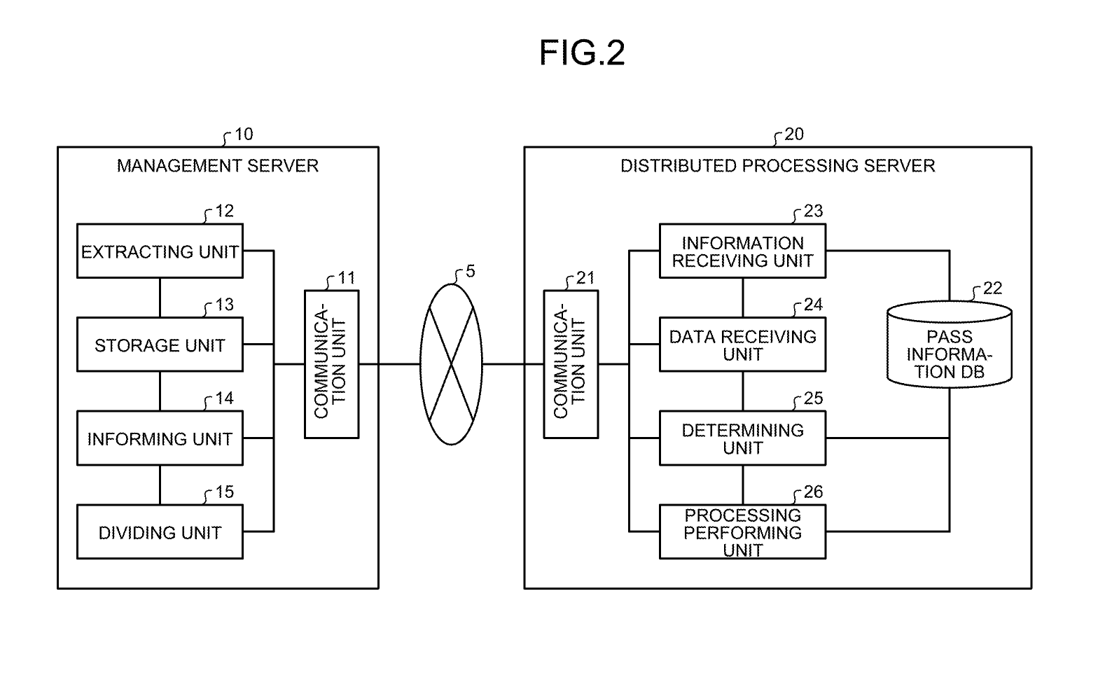

Next, a functional configuration of each device depicted in FIG. 1 is explained. Because the distributed file system 30 and the common access platform 40 have configurations similar to those of a general server, a database, and the like, detailed explanation thereof is omitted herein. FIG. 2 is a functional block diagram depicting a function configuration of the respective devices according to the first embodiment.

Configuration of Management Server 10

As depicted in FIG. 2, the management server 10 includes a communication unit 11, an extracting unit 12, a storage unit 13, an informing unit 14, and a dividing unit 15. Note that the extracting unit 12, the storage unit 13, the informing unit 14, and the dividing unit 15 are one example of a circuit included in an electronic circuit such as a processor, or one example of a process that is executed by a processor.

The communication unit 11 is a processing unit that controls communication of the other devices, and is, for example, a communication interface. For example, the communication unit 11 transmits matrix data to the distributed file system 30, transmits a header of the matrix data to the common access platform 40, and transmits divided matrix data that is obtained by dividing the matrix data to each of the distributed processing servers 20.

The extracting unit 12 is a processing unit that extracts a header of matrix data that is a subject of distributed processing, constituted of a header and data. Specifically, the extracting unit 12 extracts the first row of the matrix data as a header, and informs to the storage unit 13.

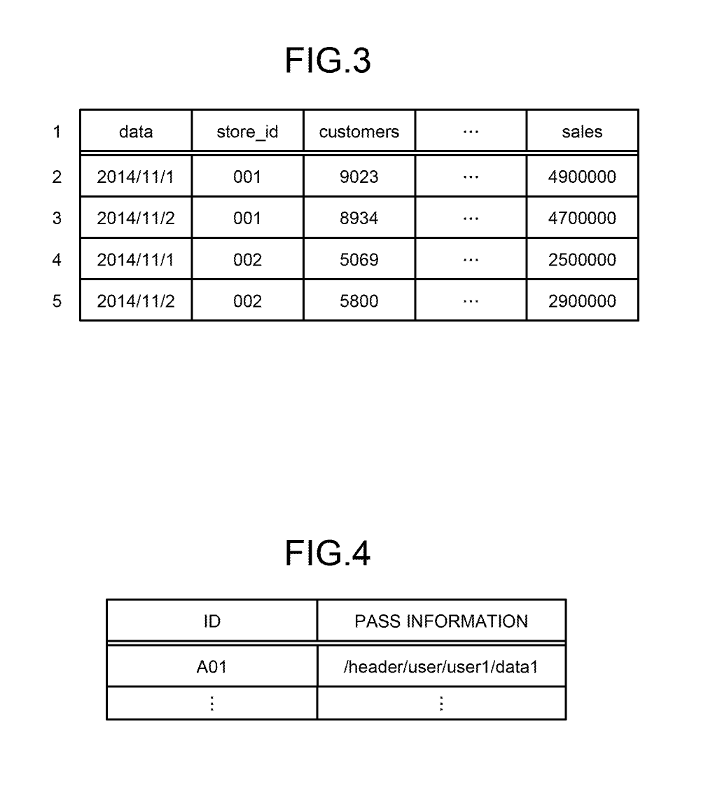

FIG. 3 depicts a data example of input data. As depicted in FIG. 3, matrix data has “data, store_id, customers, . . . , sales” as a header, and “2014/11/1, 001, 9023, . . . , 4900000” and the like as data. The extracting unit 12 extracts the first row “data, store_id, customers, . . . , sales” when the matrix data depicted in FIG. 3 is input.

The storage unit 13 is a processing unit that stores header information of matrix data, which is input data. For example, the storage unit 13 stores the header “data, store_id, customers, . . . , sales” that has been informed by the extracting unit 12 and an identifier “A01” identifying matrix data in a specified region of the common access platform 40 in an associated manner. The storage unit 13 identifies information of an access pass “/header/user/user1/data1” that identifies a storage location. Thereafter, the storage unit 13 informs the identifier “A01” that identifies the matrix data and the pass information “/header/user/user1/data1” to the informing unit 14.

The informing unit 14 is a processing unit that transmits head reference information relating to reference of header information, to each of the distributed processing servers 20 to which divided matrix data is allocated. For example, the informing unit 14 acquires the identifier “A01” that identifies the matrix data and the pass information “/header/user/user1/data1” from the storage unit 13. The informing unit 14 then transmits information such as the pass information “/header/user/user1/data1” and the identifier “A01” to each of the distributed processing servers 20. The informing unit 14 transmits an identifier and pass information together to each of the distributed processing servers 20 when multiple distributed processing are executed in parallel.

The dividing unit 15 is a processing unit that creates multiple pieces of divided matrix data that are obtained by dividing input matrix data in a row unit, and transmits it to each of the distributed processing servers 20. For example, when accepting a start time of division processing, the dividing unit 15 acquires matrix data from the extracting unit 12, and divides the matrix data in a row unit to transmit to each of the distributed processing servers 20.

As one example, the dividing unit 15 divides the matrix data depicted in FIG. 3 into two sets: a set of the first row (header) and the second row, and a set of the third row to the fifth row. The dividing unit 15 then transmits a first set to a first unit of the distributed processing servers 20, and transmits a second set to a second unit of the distributed processing servers 20. How it is divided and allocated can be arbitrarily set, and it can be executed in accordance with a protocol of the distributed processing framework, and the like.

Functional Configuration of Distributed Processing Server 20

As depicted in FIG. 2, the distributed processing server 20 includes a communication unit 21, a pass information database (DB) 22, an information receiving unit 23, a data receiving unit 24, a determining unit 25, and a processing performing unit 26. The pass information DB 22 is stored in a storage unit such as a hard disk and a memory. The information receiving unit 23, the data receiving unit 24, the determining unit 25, the processing performing unit 26 are one example of a circuit included in an electronic circuit such as a processor, or one example of a process that is executed by a processor.

The communication unit 21 is a processing unit that controls communication of the other devices, and is, for example, a communication interface, or the like. For example, the communication unit 21 receives divided matrix data obtained by dividing matrix data, pass information, and the like.

The pass information DB 22 is a database that stores information relating to a storage location of header information of matrix data. Specifically, the pass information DB 22 stores pass information that is informed by the management server 10, per matrix data.

FIG. 4 depicts an example of pass information. As depicted in FIG. 4, the pass information DB 22 stores information in which “ID, pass information” are associated with each other. “ID” indicates an identifier that identifies matrix data, and “pass information” is information to access header information. By thus managing “ID, pass information” in an associated manner, the distributed processing server 20 can acquire a header from the common access platform 40, if either one of an ID or pass information is obtained.

The information receiving unit 23 is a processing unit that receives pass information from the management server 10. For example, the information receiving unit 23 receives “ID, pass information” from the management server 10 as pass information, to store in the pass information DB 22.

The data receiving unit 24 is a processing unit that receives data of a subject of distributed processing. Specifically, the data receiving unit 24 receives divided matrix data that is obtained by dividing matrix data in a row unit from the management server 10, to output to the determining unit 25. For example, the data receiving unit 24 receives divided matrix data that is constituted of the first row and the second row of the matrix data depicted in FIG. 3.

The determining unit 25 is a processing unit that determines whether a header is present in data received by the data receiving unit 24. Specifically, the determining unit 25 makes determination by comparing attributes of a first row and rows thereafter, and informs a determination result to the processing performing unit 26. An attribute is a character string (string type), a numeric value (int type, double type“), or the like. Because a header is read by a person, it is often a character string. Therefore, the determining unit 25 determines that a header is included in input data, when a line including the first row and the second row having different attributes are included therein.

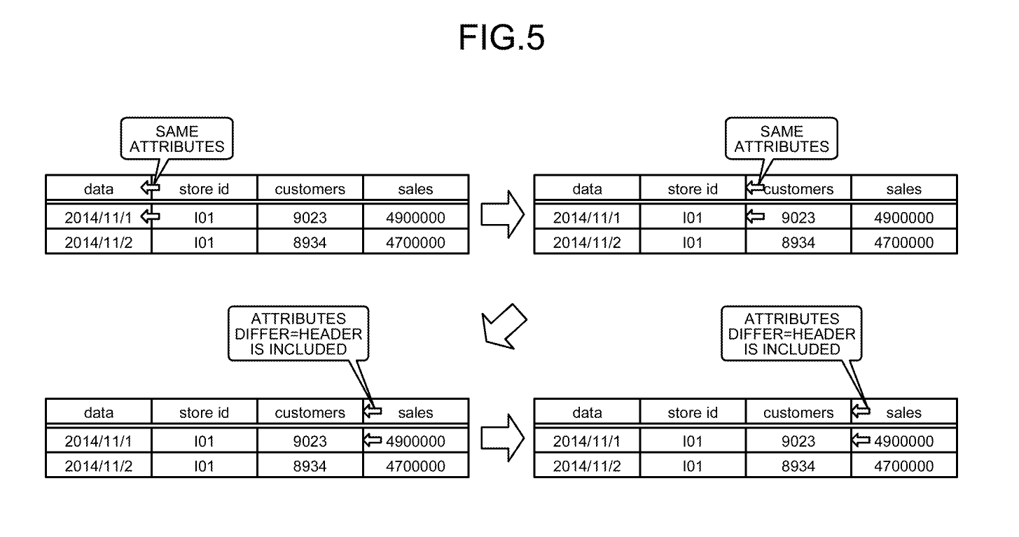

FIG. 5 is an explanatory diagram of a method of determining that a header is present. As depicted in FIG. 5, the determining unit 25 first compares “data” in a first column and “2014/11/1” in the first column of the first row, and determines that both are the string type because the second row include “/”, to determine as the same attributes. Subsequently, the determining unit 25 compares “store_id” in a second column of the first row and “I01” in the second column of the second row, and determines that both are the string type because the second row includes “I”, to determine as the same attributes. Furthermore, the determining unit 25 compares “customers” in a third column of the first row and “9023” in the third column on the second row, and determines as different attributes because the attributes are a character string and a numeric value. As a result, in the example of FIG. 5, the determining unit 25 determines as data including a header.

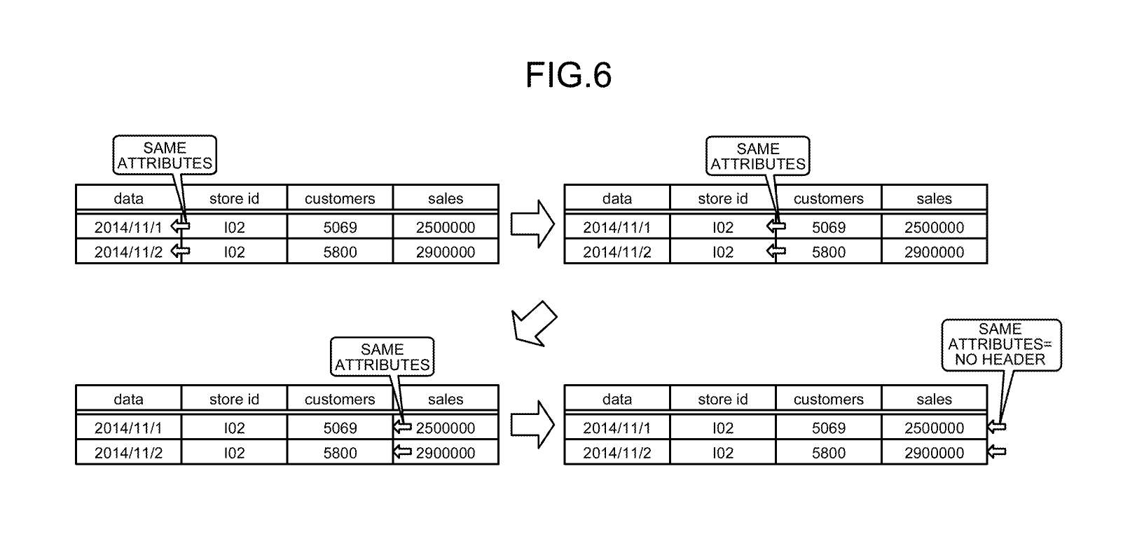

Subsequently, FIG. 6 is an explanatory diagram of a method of determining that a head is absent. As depicted in FIG. 6, the determining unit 25 first compares “2014/11/1” in the first column on the first row and “2014/11/2” in the first column on the second row, and determines that both as the character string type because the both includes “/”, to determine as the same attributes. Subsequently, the determining unit 25 compares “I02” in the second column on the first row and “I02” in the second column on the second row, and determines that both are the character string type because the both includes “I”, to determine as the same attributes. Moreover, the determining unit 25 compares “2500000” in a fourth column on the first row and “2900000” in the fourth column on the second row, and determines as the same attributes because the attributes of the both are numeric values. As a result, in the example of FIG. 6, the determining unit 25 determines as data without a header.

The determining unit 25 can perform determination of whether the same attributes or different attributes for each column on the first row and the second row of divided matrix data received, and the number of rows can be determined in advance as a subject of determination such that rows up to the 30th row are the subject of determination.

Furthermore, the determining unit 25 acquires header information from the common access platform 40 by using the pass information stored in the pass information DB 22. The determining unit 25 can determine as data including a header when a first row of divided matrix data received and the header information read from the common access platform 40 coincide with each other.

The processing performing unit 26 is a processing unit that executes corresponding processing on divided matrix data received. Specifically, the processing performing unit 26 executes statistical processing and the like using the R application with assumption of presence of a header, on the divided matrix data received, and stores a result thereof in the distributed file system 30.

For example, when a determination result of header included and divided matrix data are acquired from the determining unit 25, the processing performing unit 26 executes corresponding processing handling a first row of the received divided matrix data as header information. The processing performing unit 26 then stores a processing result in the distributed file system 30.

On the other hand, when a determination result of header included and reception data are acquired from the determining unit 25, the processing performing unit 26 reads the pass information “/header/user/user1/data1” from the pass information DB 22. The processing performing unit 26 then accesses the common access platform 40 using read “/header/user/user1/data1” to acquire header information, and uses it as the first row of the reception data. Thereafter, the processing performing unit 26 executes corresponding processing handling the first row that is added to the reception data as the header information. The processing performing unit 26 then deletes the header information from the processing result to store in the distributed file system 30.

Processing of Management Server

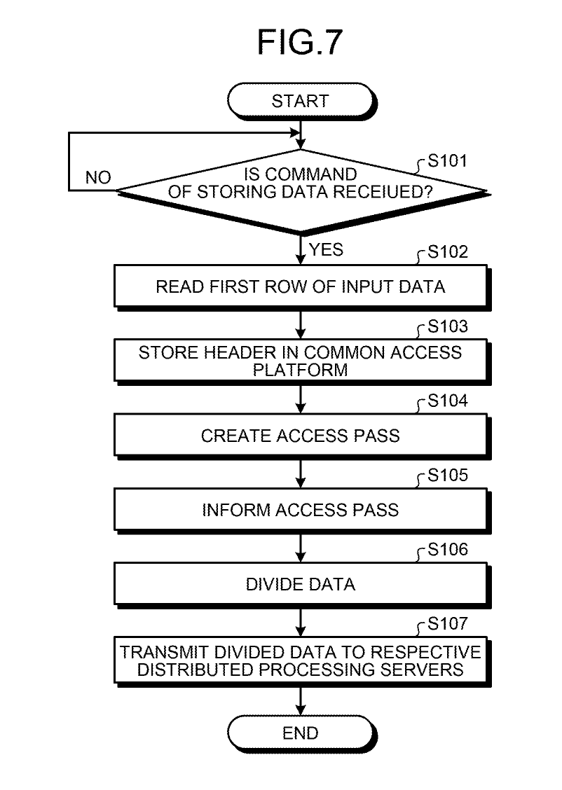

FIG. 7 is a flowchart indicating a flow of processing executed by the management server. As indicated in FIG. 7, when a command of storing data is received from an administrator or the like (S101: YES), the extracting unit 12 reads a first row of input data (S102).

Subsequently, the storage unit 13 stores the first row of the input data that is read by the extracting unit 12 in the common access platform 40 as header information (S103). The storage unit 13 then creates an access pass to a region in which the header information is stored (S104), and informs the created access pass to each of the distributed processing servers 20 as pass information (S105).

Thereafter, the dividing unit 15 stores the input data in the distributed file system 30, divides the input data in a row unit (S106), and transmits divided matrix data to each of the distributed processing servers 20 (S107).

Processing of Distributed Processing Server

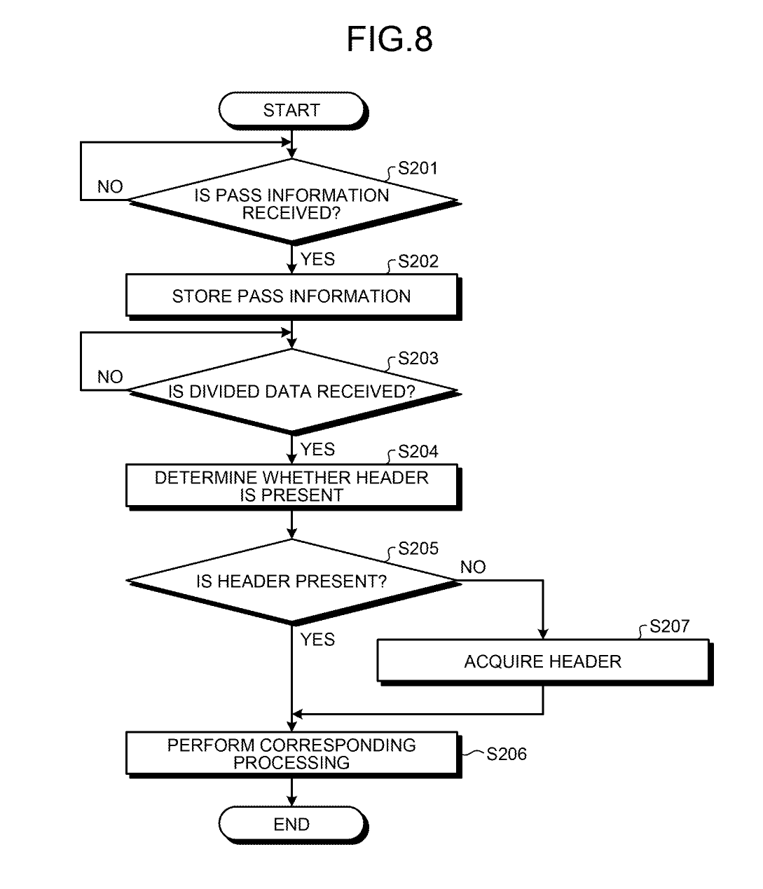

FIG. 8 is a flowchart indicating a flow of processing executed by the distributed processing server. As depicted in FIG. 8, when pass information is received from the management server 10 (S201: YES), the information receiving unit 23 stores the received pass information in the pass information DB 22 (S202).

When the data receiving unit 24 receives divided matrix data from the management server 10 (S203: YES), the determining unit 25 determines whether a header is present in the received divided matrix data (S204).

Thereafter, when the determining unit 25 determines that a header is included (step S205: YES), the processing performing unit 26 executes corresponding processing using the first row of the reception data as header information (S206).

On the other hand, when the determining unit 25 determines that a header is not included (S205: NO), acquires header information from the common access platform 40 using pass information stored in the pass information DB (S207). Thereafter, the processing performing unit 26 adds header information that has been added as the first row of the reception data, to perform corresponding processing (S206).

As described above, the distributed processing servers 20 can perform parallel processing without correcting input data or the R application, even if order of items of input data is switched, or appearance order of items that has been used is changed because a new item is added. Moreover, this enables to suppress cost used for operation maintenance significantly.

### [b] Second Embodiment

Although general distributed processing has been explained in the first embodiment, the same method can be applied also to, for example, MapReduce processing of Hadoop (registered trademark). Therefore, in a second embodiment, an example in which MapReduce processing is applied is explained.

System Stuck

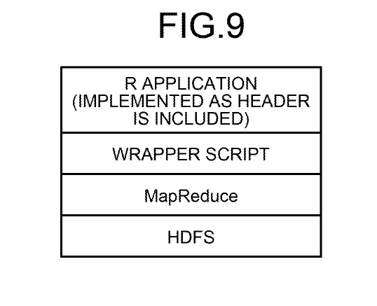

FIG. 9 is an explanatory diagram of an example of system stuck of the distributed processing server that executes MapReduce processing. As depicted in FIG. 9, the respective distributed processing servers 20 executes a distributed file system (HDFS), MapReduce, a wrapper script, and an R application. The R application corresponds to the processing performing unit 26, and MapReduce and the wrapper script correspond to the data receiving unit 24 and the determining unit 25.

In Hadoop, before processing data, input data is stored in the HDFS. Storage of a header in the common access platform 40 is executed in timing when the input data is stored in the HDFS.

When accepting a command of storing input data in the HDFS from a user, the management server 10 extracts header information from the input data, and stores the extracted header information in the common access platform 40, and stores the input data in the HDFS.

Specifically, the wrapper script is executed as a Map task or a Reduce task. The R application receives the input data from the wrapper script. The wrapper script compares a first row and a second row in divided input data (divided matrix data), and determines that a header is included therein when data types of the first row and the second row are different. On the other hand, when the data types of the first row and the second row are the same, the wrapper script determines that a header is not included.

When a header is not included, the wrapper script reads a corresponding header from a pass of the input data (divided matrix data) from the common access platform 40, and transmits it to the R application prior to the divided data. As for a method of acquiring a pass of input data for the wrapper script, a method of distributing to the respective distributed processing servers 20 through an environment variable, and the like can be applied.

Flow of Data

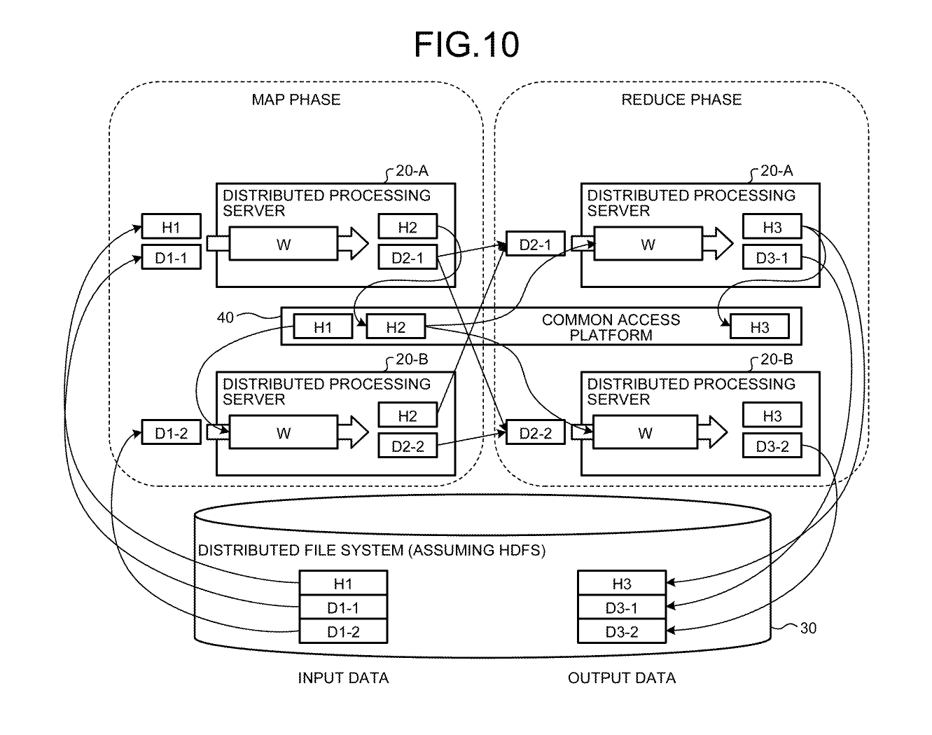

FIG. 10 is an explanatory diagram of an application example to MapReduce processing. “H” indicated in FIG. 10 signifies a header, “D” signifies data, and “W” signifies a wrapper script. Moreover, numerals indicate order of data, and 1 indicates that it is before Map processing, 2 indicates that it is after Map processing, and 3 indicates that it is after Reduce processing. Furthermore, in the example depicted in FIG. 10, it is assumed that header information “H1” of input data has already been stored in the common access platform 40.

Map Phase

First Map processing is explained. As depicted in FIG. 10, the wrapper script of a distributed processing server 20-A receives divided matrix data of (H1)+(D1-1), and continues the processing because a header is included therein. The wrapper script of the distributed processing server 20-A creates (H2)+(D2-1), and extracts H2 to store in the common access platform 40. The distributed processing server 20-A may store H2 on the same access pass as H1, and when storing in another region, transmits an access pass to the stored region, to the respective distributed processing servers 20.

On the other hand, a wrapper script of a distributed processing server 20-B receives divided matrix data of (D1-2), and acquires header information (H1) from the common access platform 40 using pass information that has been informed in advance, because a header is not included therein. The wrapper script of the distributed processing server 20-B executes processing with (H1)+(D1-2) as input data, creates (H2)+(D2-2), and removes H2.

Reduce Phase

Next, Reduce processing is explained. As depicted in FIG. 10, the wrapper script of the distributed processing server 20-A acquires an own Map processing result “D2-1” and a processing result “D2-2” of the distributed processing server 20-B. The wrapper script of the distributed processing server 20-A then acquires header information (H2) from the common access platform 40 using pass information that has been informed in advance because a header is not included in data “(D2-1)+(D2-2) of a subject of processing. The wrapper script of the distributed processing server 20-A executes processing with (H2)+(D2-1)+(D2-2) as input data, and creates (H3)+(D3-1). Thereafter, the wrapper script of the distributed processing server 20-A stores H3 in the common access platform 40, and stores D3-1 in the distributed file system 30.

On the other hand, the wrapper script of the distributed processing server 20-B acquires the own Map processing result “D2-2” and the processing result “D2-1” of the distributed processing server 20-A. The wrapper script of the distributed processing server 20-B then acquires the header information (H2) from the common access platform 40 using the pass information that has been informed in advance because a header is not included in data “(D2-1)+(D2-2) of a subject of processing. The wrapper script of the distributed processing server 20-B executes processing with (H2)+(D2-1)+(D2-2) as input data, and creates (H3)+(D3-2). Thereafter, the wrapper script of the distributed processing server 20-B stores D3-2 obtained by removing H2 therefrom, in the distributed file system 30.

Flow of Processing

Next, Map processing and Reduce processing that are executed by the distributed processing servers 20 are explained. Although following processing differs in that input data is input from the distributed file system 30 or from the respective distributed processing servers 20, a flow of processing is the same, and therefore, Map processing is explained herein.

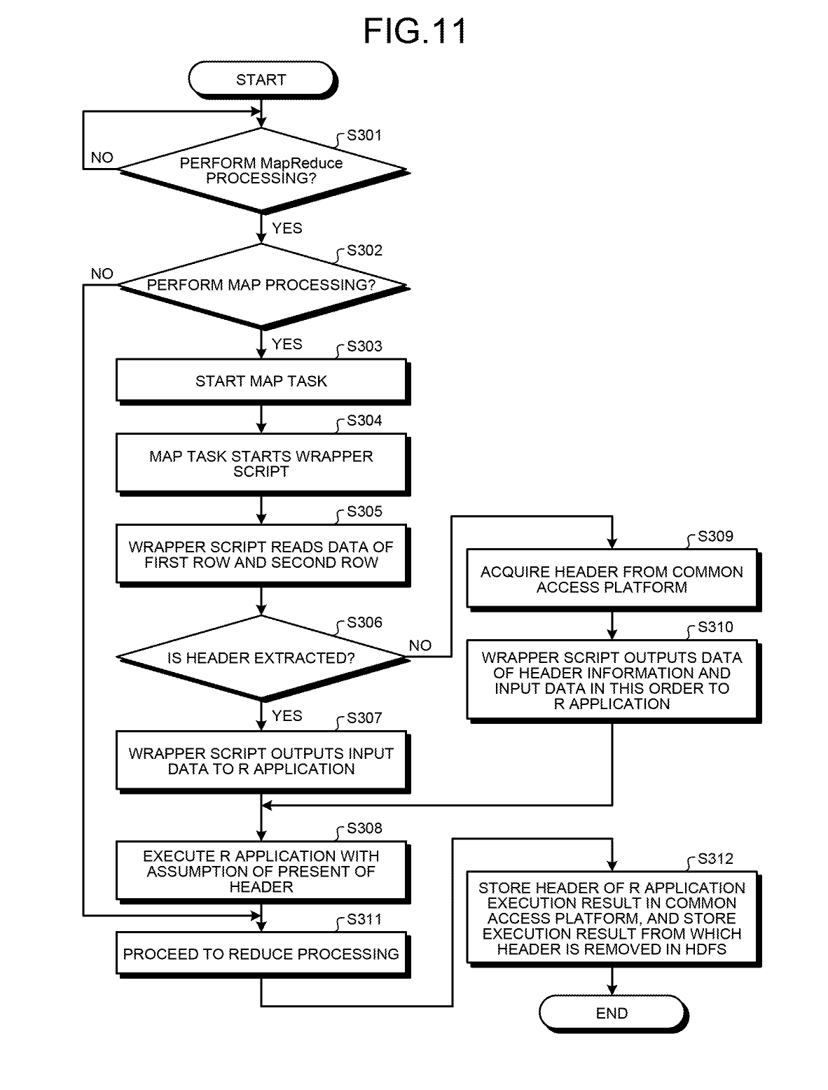

FIG. 11 is a flowchart indicating a flow of Map processing executed by the distributed processing server according to a second embodiment. As indicated in FIG. 11, when instructed to perform MapReduce processing by an administrator or the management server 10 (S301: YES), the distributed processing server 20 executes Map processing (S302: YES), and starts Map task (S303).

The Map task starts the wrapper script (S304), and the wrapper script reads data of the first row and the second row (S305). When a header is extracted from the read data (S306: YES), the wrapper script outputs the input data to the R application (S307). Thereafter, the distributed processing server 20 executes the R application with the assumption of presence of a header (S308).

On the other hand, when a header is not extracted from the read data (S306: NO), the wrapper script acquires a header from the common access platform 40 (S309). The wrapper script then outputs header information and the input data in this order, to the R application (S310). Thereafter, the distributed processing server 20 executes the R application with the assumption of presence of a header (S308).

When Map processing is finished, the distributed processing server 20 executes Reduce processing (S311), and when Reduce processing is finished, stores a header of an execution result of the R application in the common access platform 40, and stores the execution result from which the header is removed in HDFS (S312). Note that when a request for Reduce processing instead of Map processing is received (S302: NO), S311 is executed instead of S303.

As described above, because it is possible to process similarly in MapReduce processing that has been spreading in recent years, speedup in processing can be achieved by performing appropriate distributed processing, and construction of a highly versatile system can be achieved.

### [c] Third Embodiment

The embodiments of the present invention have been explained, and the present invention may be implemented in various different forms other than the embodiments explained above. Different embodiments are explained below.

Reference Information

Although an example in which pass information is informed to the respective distributed processing servers 20 as information to identify header information that is stored in the common access platform 40 is explained in the above embodiments, it is not limited thereto. For example, having an identifier identifying input data and pass information stored in the common access platform 40 in an associated manner, the management server 10 may inform the identifier to the respective distributed processing servers 20. Moreover, pass information may be created each time by the management server 10, or may be specified in advance by an administrator, or the like. That is, as long as a storage location of a header is uniquely determined when input data is determined, any kind of method can be applied.

Input Data

The numbers of rows and columns of matrix data depicted in the above embodiments are not limited to ones in the depicted example, but may be changed appropriately.

System

Moreover, out of respective processing explained in the present embodiment, all or a part of processing that has been explained to be executed automatically may be executed manually. Alternatively, all or a part of processing that has been explained to be executed manually may be executed automatically by a known method. In addition, processing procedures, control procedures, specific names, and information including various kinds of data and parameters explained in the description or in the drawings may be changed arbitrarily unless otherwise specified.

In addition, each component of each apparatus illustrated in the drawings is functionally conceptual and thus does not always physically configured as illustrated in the drawings. Namely, a specific mode of separation or integration of each apparatus is not limited to that illustrated in the drawings. That is, all or some of the components can be configured by separating or integrating them functionally or physically in any unit, according to various types of loads, the status of use, etc. Furthermore, all or arbitrary ones of processing functions performed by each apparatus can be implemented by a central processing unit (CPU) and a program analyzed and executed by the CPU or implemented by wired logic hardware.

Hardware

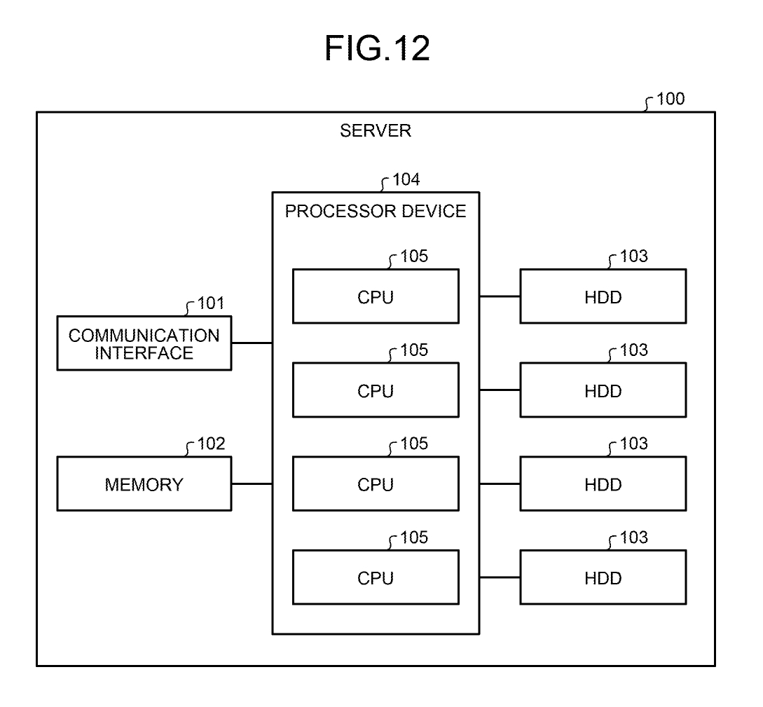

Next, a hardware configuration example of respective servers is explained. Because the respective servers have the same configuration, one example is explained herein. FIG. 12 depicts a hardware configuration example of each server. As depicted in FIG. 12, a server 100 includes a communication interface 101, a memory 102, hard disk drives (HDD) 103, and a processor device 104.

The communication interface 101 corresponds to the communication control unit indicated in explaining the respective functional units, and is, for example, a network interface card, and the like. The multiple HDDs 103 store programs to operate the processing units indicated in explaining the respective functional units, DB, and the like.

Multiple CPUs 105 included in the processor device 104 causes to perform processes that implement the respective functions explained in FIG. 2 and the like by reading a program to perform processing similar to the respective processing units indicated in explaining the respective functional units, and by developing it on the memory 102. That is, this process executes the same functions as the extracting unit 12, the storage unit 13, the informing unit 14, and the dividing unit 15 included in the management server 10. Moreover, this process executes the same functions as the information receiving unit 23, the data receiving unit 24, the determining unit 25, and the processing performing unit 26 that are included in the distributed processing server 20.

As described, the server 100 operates as an information processing apparatus that executes a distributed processing method, by reading and executing the program. Furthermore, the server 100 reads the above program from a recording medium by a medium reading device, and executes the above read program, thereby enabling to implement the similar functions as those of the embodiments described above. Note that the program in this embodiment is not limited to be executed by the server 100. For example, also when the program is executed by another computer or a server, or when the program is executed by these in cooperation, the present embodiment can be similarly applied.

According to the embodiment, distributed processing can be executed appropriately.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process comprising:
extracting header information from matrix data that includes the header information and data;
creating a plurality of pieces of divided matrix data that are obtained by dividing the matrix data in a row unit; and
transmitting header reference information relating to reference of the header information to each of a plurality of servers being a subject of instruction to which the divided matrix data are allocated.

2. The non-transitory computer-readable recording medium according to claim 1, wherein
the transmitting includes transmitting the header reference information to an application that is executed in the each of a plurality of servers and that executes statistical processing, handling a first row of input data as header information.

3. The non-transitory computer-readable recording medium according to claim 1, wherein
the extracting includes storing the header information in a region accessible for the each of a plurality of servers, and
the transmitting includes transmitting the header reference information including pass information relating to the region.

4. The non-transitory computer-readable recording medium according to claim 1, wherein
the extracting includes storing the header information and an identifier that identifies the matrix data in a region accessible for the each of a plurality of servers, in an associated manner, and
the transmitting includes transmitting the header reference information including the identifier.

5. A distributed processing method comprising:
extracting header information from matrix data that includes the header information and data;
creating a plurality of pieces of divided matrix data that are obtained by dividing the matrix data in a row unit; and
transmitting header reference information relating to reference of the header information to each of a plurality of servers being a subject of instruction to which the divided matrix data are allocated.

6. A non-transitory computer-readable recording medium having stored therein a program that causes a computer to execute a process comprising:
receiving header reference information relating to reference of header information of matrix data that includes the header information and data;
receiving divided matrix data that is obtained by dividing the matrix data in a row unit;
executing predetermined processing on the divided matrix data when the header information is included in the divided matrix data, and executing the predetermined processing after acquiring the header information using the header reference information when the header information is not included in the divided matrix data.
